(19) United States
(12) Patent Application Publication
(10) Pub. No.: US 2014/0030556 A1
(43) Pub. Date: Jan. 30, 2014

(54) CIRCUIT BOARD TO CIRCUIT BOARD CONNECTOR WITH VERTICAL AND LONGITUDINAL ASSEMBLY ALIGNMENT FEATURES

(71) Applicant: Robert C. Beer, Noblesville, IN (US)

(72) Inventor: Robert C. Beer, Noblesville, IN (US)

(73) Assignee: DELPHI TECHNOLOGIES, INC., Troy, MI (US)

(21) Appl. No.: 13/561,396

(22) Filed: Jul. 30, 2012

(51) Int. Cl. H01R 12/73; H01M 2/00

(52) U.S. Cl. 429/7; 439/629

(57) ABSTRACT

An electrical connector assembly and a battery pack system utilizing the electrical connector assembly are described. The electrical connector assembly includes a first connector body defining a first locating pin and a second connector body defining a first location socket. The first connector body may also define a second locating socket and the second connector body may define a second locating pin having the same shape as the first locating pin and first locating socket. The electrical connection between the first and second connector bodies is established by a conductor connected between the terminals. The locating pins and locating sockets provide lateral location of the terminals relative to each other. The terminals or the conductor may define a U-shaped portion that provides longitudinal and vertical assembly tolerance of the terminals in the first connector body relative to the terminals in the second connector body.

### TECHNICAL FIELD OF INVENTION

The invention generally relates to an electrical connector assembly, and more particularly relates to an electrical connector assembly configured to interconnect one circuit board to another circuit board.

### BACKGROUND OF INVENTION

Electrical connections between circuit boards in electronic assemblies have typically been made using two different electrical connection technologies. The first is a wiring harness consisting of discrete wires that is connected from a wiring connector on one circuit board to a wiring connector on the other circuit board. This connection technology is well suited for circuit boards that are physically separated, however the wiring connectors and the wiring harness require significant packaging space. For circuit boards that are located adjacent to each other, another connection technology wherein the circuit boards are electrically connected by a header with male pins on one circuit board and a header with female sockets on the other circuit board may be used. However, these connectors are sensitive to physical alignment between the pins and the sockets to make a proper electrical connection. This may require maintaining tight assembly tolerances between circuit boards during the circuit board assembly process.

### SUMMARY OF THE INVENTION

In accordance with one embodiment of this invention, an electrical connector assembly configured to interconnect a plurality of circuit boards is provided. The electrical connector assembly includes a first terminal formed of electrically conductive material. The first terminal is configured to define a U-shaped portion and electrically connect to a first circuit board. The electrical connector assembly also includes a second terminal formed of electrically conductive material. The second terminal is configured to define a U-shaped portion and electrically connect to a second circuit board. The assembly additionally includes a conductor disposed within the U-shaped portion of the first terminal and disposed within the U-shaped portion of the second terminal. The assembly further includes a first connector body configured to position the first terminal relative to a first locating pin defined by the first connector body. The first locating pin is configured to protrude from the first connector body. The assembly also includes a second connector body configured to position the second terminal relative to a first locating socket defined by the second connector body. The first locating socket having a shape complementary to the first locating pin. The first locating pin and the first locating socket cooperate to align the first terminal and the second terminal in a lateral direction.

The first connector body may be configured to be disposed proximate to a first circuit board edge and the second connector body may be configured to be disposed proximate to a second circuit board edge. The first circuit board may be substantially coplanar with the second circuit board.

The second connector body may further define a second locating pin. The second locating pin may be configured to protrude from the second connector body. The first connector body may further define a second locating socket within the first connector body having a shape complementary to the second locating pin. The second locating pin and the second locating socket may cooperate to further align the first connector body and the second connector body in the lateral direction.

The first locating pin and the second locating pin may define the same shape. The first locating pin may be tapered.

The first locating pin and the first locating socket may define interlocking shapes. The first locating pin may define a head portion and a body portion, wherein the head portion is wider than the body portion in order to define the interlocking shape. The head portion of the first locating pin may define a frustoconical shape and the body portion defines a trapezoidal prism shape. The first locating socket may define a keyhole shape.

The first locating pin and the first locating socket may be configured to mechanically couple the first circuit board to the second circuit board and cooperate to align the first terminal and the second terminal in a longitudinal direction.

The conductor may be disposed within a cover configured to mechanically couple the first circuit board to the second circuit board and to align the first terminal and the second terminal in a longitudinal direction.

The conductor may define a blade shape. The first terminal and the second terminal may define a tuning fork shape.

In another embodiment of the present invention, an electrical connector assembly configured to interconnect a plurality of circuit boards is provided. The electrical connector assembly includes a first terminal formed of electrically conductive material. The first terminal is configured to electrically connect to a first circuit board. The electrical connector assembly also includes a second terminal formed of electrically conductive material. The second terminal is configured to electrically connect to a second circuit board. The electrical connector assembly additionally includes a conductor defining a first leg portion a and a second leg portion wherein the first terminal is disposed within a U-shaped portion defined by the first leg portion and the second terminal is disposed within a U-shaped portion defined by the second leg portion. The electrical connector assembly further includes a first connector body containing the first terminal and defining a first locating pin protruding from the first connector body and a second connector body containing the second terminal and defining a first locating socket within the second connector body having a shape complementary to the first locating pin. The first locating pin and the first locating socket cooperate to align the first terminal and the second terminal in a lateral direction.

The first connector body may be configured to be disposed proximate to a first circuit board edge and the second connector body may be configured to be disposed proximate to a second circuit board edge. The first circuit board may be substantially coplanar with the second circuit board.

The second connector body may further define a second locating pin. The second locating pin may be configured to protrude from the second connector body. The first connector body may further define a second locating socket within the first connector body having a shape complementary to the second locating pin. The second locating pin and the second locating socket may cooperate to further align the first connector body and the second connector body in the lateral direction.

The first locating pin and the second locating pin may define the same shape. The first locating pin and the second locating pin may be tapered.

The first locating pin and the first locating socket may define interlocking shapes. The first locating pin may define a head portion and a body portion, wherein the head portion is wider than the body portion in order to define the interlocking shape. The head portion of the first locating pin may define a frustoconical shape and the body portion defines a trapezoidal prism shape. The first locating socket may define a keyhole shape.

The first locating pin and the first locating socket may be configured to mechanically couple the first circuit board to the second circuit board and cooperate to align the first terminal and the second terminal in a longitudinal direction.

The conductor may be disposed within a cover that is configured to mechanically couple the first circuit board to the second circuit board and to align the first terminal and the second terminal in a longitudinal direction.

In another embodiment of the present invention, a battery pack system configured for use in an electrical vehicle is provided. The battery pack system includes a first battery further comprising a first circuit board and a second battery further comprising a second circuit board. The second battery is electrically connected to the first battery via the first circuit board and the second circuit board. The system also includes an electrical connector assembly that is configured to interconnect the circuit first board and the second circuit board. The electrical connector assembly further includes a first electrically conductive terminal defining a U-shaped portion and electrically connected to the first circuit board and a second electrically conductive terminal defining a U-shaped portion and electrically connected to the second circuit board. A conductor is disposed within the U-shaped portion of the first terminal and disposed within the U-shaped portion of the second terminal. The system further includes a first connector body containing the first terminal and defining a first locating pin protruding from the first connector body and a second connector body containing the second terminal and defining a first locating socket within the second connector body having a shape complementary to the first locating pin. The first locating pin and the first locating socket cooperate to align the first terminal and the second terminal in a lateral direction.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is perspective view of a battery pack system including a first and second circuit board connected by an electrical connector assembly in accordance with one embodiment;

FIG. 2 is an exploded perspective view of the electrical connector assembly in accordance with one embodiment;

FIG. 3A is a perspective view of a first connector body and a second connector body illustrating the relationship between a first locating pin and a first locating socket in accordance with one embodiment;

FIG. 3B is a perspective view of a first connector body and a second connector body illustrating the relationship between a first locating pin and a first locating socket when the connector bodies are assembled in accordance with one embodiment;

FIG. 4 is perspective view of the cover for the electrical connector assembly including the conductor in accordance with one embodiment;

FIG. 5 is perspective view of the electrical connector assembly including the cover in accordance with one embodiment;

FIG. 6 is a cross sectional view of the electrical connector assembly of FIG. 5 in accordance with one embodiment;

FIG. 7 is an exploded perspective view of the electrical connector assembly in accordance with another embodiment; and

FIG. 8 is an exploded perspective view of the electrical connector assembly in accordance with yet another embodiment.

### DETAILED DESCRIPTION OF INVENTION

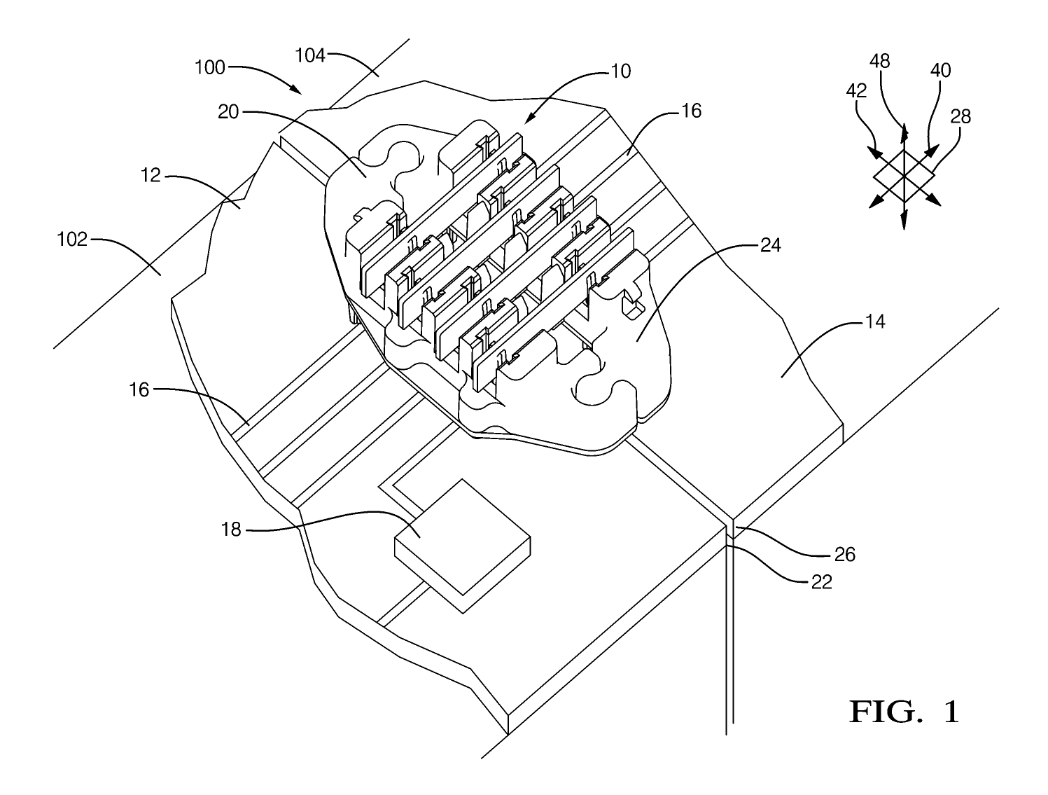

FIG. 1 illustrates a non-limiting example of an electrical connector assembly 10 configured to interconnect a first circuit board 12 and a second circuit board 14. The first circuit board 12 and the second circuit board 14 may be a printed circuit board (PCB) containing conductive traces 16 configured to connect electrical components 18. The first circuit board 12 and the second circuit board 14 may be made from epoxy or polyimide resins. The resin may be reinforced with a woven glass cloth or other matrix such as chopped fibers. Circuit boards formed of such materials are typically called FR-4 or G-10 type circuit boards. The first circuit board 12 and second circuit board 14 may alternately be constructed of ceramic or rigid polymers. This listing of acceptable circuit board materials is not exhaustive and other materials may also be used successfully. The materials and manufacturing techniques used to form printed circuit boards are well known to those skilled in the art. The first circuit board 12 and the second circuit board 14 do not have to be made of the same material.

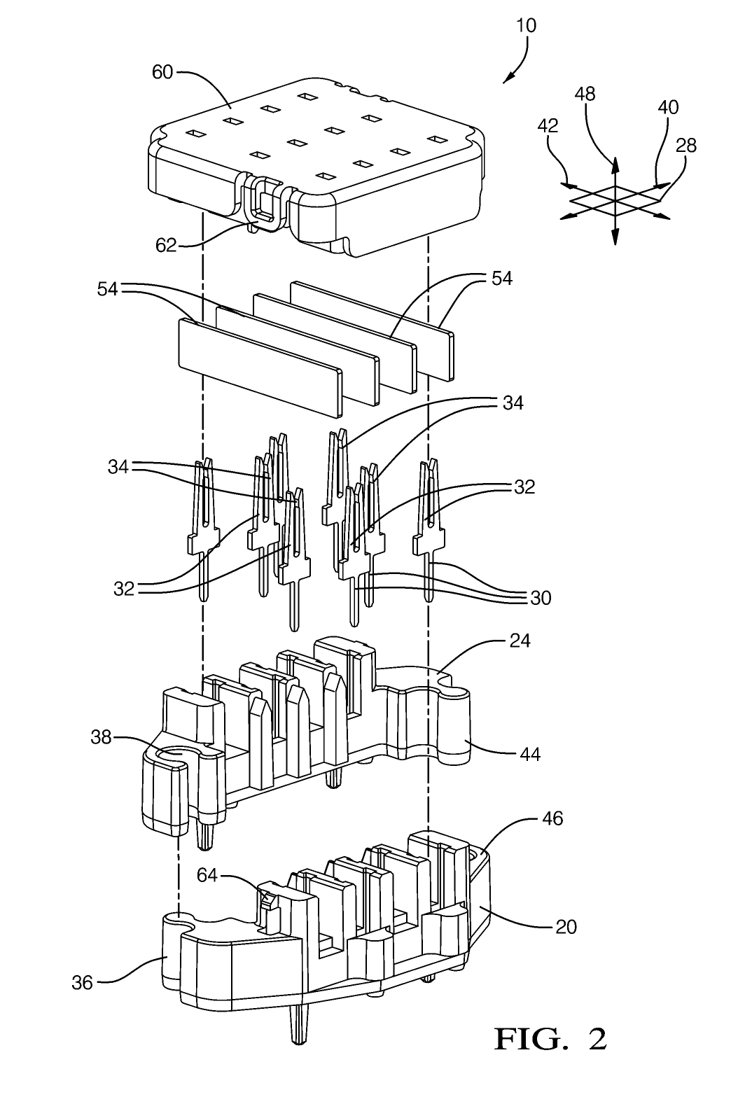

A first connector body 20 may be configured to be disposed proximate to a first circuit board edge 22 and a second connector body 24 may be configured to be disposed proximate to a second circuit board edge 26. As used herein, a connector body is the portion of the electrical connector assembly 10 that provides locating features for the terminals (e.g. first terminal 30, second terminal 34, see FIG. 2) and provides mechanical support for the terminals. The first circuit board 12 may be substantially coplanar with the second circuit board 14. As used herein, substantially coplanar means the plane 28 formed in the lateral direction 40 and longitudinal direction 42 of the first circuit board 12 is ±5° and ±5 millimeters of absolutely coplanar with the plane 28 formed in the lateral direction 40 and longitudinal direction 42 of the second circuit board 14. The first circuit board edge 22 may abut the second circuit board edge 26. Alternatively, the first connector body 20 or the second connector body 24 may be located in the interior portion of the first circuit board 12 or the second circuit board 14 rather than on the periphery of the circuit board. The first circuit board edge 22 may overlap the second circuit board edge 26.

FIG. 2 illustrates a non-limiting example of the electrical connector assembly 10, wherein the electrical connector assembly 10 includes The electrical connector assembly 10 includes a first terminal 30 formed of electrically conductive material. The first terminal 30 is configured to define a U-shaped portion 32 and electrically connect to the conductive traces 16 on the first circuit board 12. The electrical connector assembly 10 also includes a second terminal 34 formed of electrically conductive material. The second terminal 34 is configured to define a U-shaped portion 32 and electrically connect to the conductive traces 16 on the second circuit board 14. As used herein, a U-shaped portion is a portion of the terminal or conductor having an open end, a closed end opposite the open end, and two sides both adjacent to the closed end and opposite each other. The first terminal 30 and the second terminal 34 may be formed of an electrically conductive material such as copper alloys, brass, or beryllium copper typically with a thickness of 0.64 millimeters to 0.8 millimeters. The first terminal 30 and the second terminal 34 are preferably tin plated. Silver or gold plating may also be used, but may not be preferred due to typically higher cost than tin plating.

The electrical connector assembly 10 further includes the first connector body 20 configured to position the first terminal 30 relative to a first locating pin 36 defined by the first connector body 20. The first locating pin 36 is configured to protrude from the first connector body 20. The electrical connector assembly 10 also includes the second connector body 24 configured to position the second terminal 34 relative to a first locating socket 38 defined by the second connector body 24. The first locating socket 38 has a shape complementary to the first locating pin 36. The first locating pin 36 and the first locating socket 38 cooperate to align the first terminal 30 and the second terminal 34 in a lateral direction 40. The first terminal 30 may be press fit into the first connector body 20 or the first terminal 30 may be insert molded into the first connector body 20. Likewise, the second terminal 34 may be press fit into the second connector body 24 or the second terminal 34 may be insert molded into the second connector body 24. The first connector body 20 and the second connector body 24 may be formed of a polymeric material such as polyamide (NYLON®), polyester, or polypropylene. The second connector body 24 may be formed of a different material than the first connector body 20. The techniques for press fitting and insert molding terminals into connector bodies are well known to those skilled in the art.

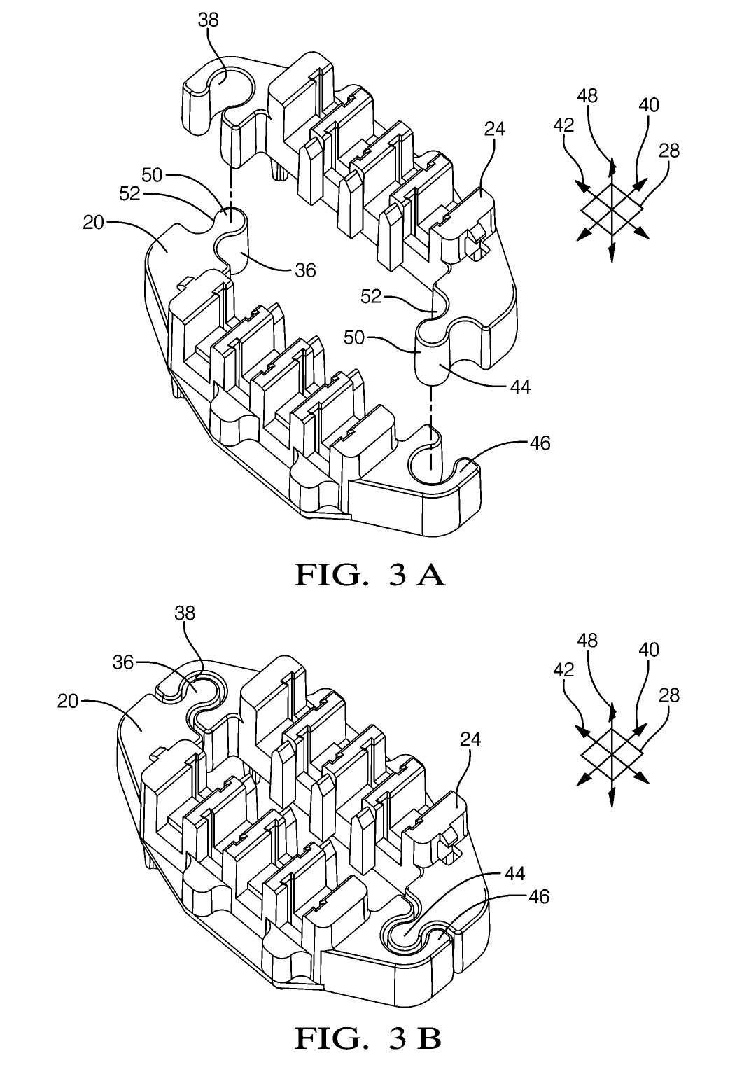

FIG. 3 illustrates a first locating pin 36 protruding from the first connector body 20 and the second connector body 24 defining a first locating socket 38 within the second connector body 24. The first locating socket 38 has a shape that is complementary to the first locating pin 36. As used herein, a complementary shape is a shape that fits together with another shape, such as a key in a lock. The first locating pin 36 and the first locating socket 38 cooperate to align the first connector body 20 and the second connector body 24 in a lateral direction 40 and thereby align the first terminal 30 and the second terminal 34 in the lateral direction 40. The first locating pin 36 and the first locating socket 38 may also cooperate to align the first connector body 20 and the second connector body 24 in a longitudinal direction 42 and thereby further align the first terminal 30 and the second terminal 34 in the longitudinal direction 42. The first connector body 20 may also define a circuit board locator pin configured to locate the first connector body 20 on the first circuit board 12 in the lateral and longitudinal direction 42.

The second connector body 24 further may define a second locating pin 44 protruding from the second connector body 24 and the first connector body 20 may further define a second locating socket 46 within the first connector body 20 having a shape complementary to the second locating pin 44. The second locating pin 44 and the second locating socket 46 may cooperate to further align the first connector body 20 and the second connector body 24 in the lateral direction 40. The second connector body 24 may also define a circuit board locator pin configured to locate the second connector body 24 on the second circuit board 14 in the lateral and longitudinal direction 42.

The first locating pin 36 and the second locating pin 44 may define the same shape, therefore the first locating socket 38 and the second locating socket 46 may also define the same shape in order to define a complementary shape to the first locating pin 36 and the second locating pin 44.

The first locating pin 36 and the first locating socket 38 and the second locating pin 44 and the second locating socket 46 may be configured to mechanically couple the first circuit board 12 to the second circuit board 14 and cooperate to align the first terminal 30 and the second terminal 34 in a longitudinal direction 42. The first terminal 30 and the second terminal 34 may define the same shape so that the first terminal 30 and the second terminal 34 may be interchangeable in the electrical connector assembly 10. The first locating pin 36 and first locating socket 38 and the second locating pin 44 and the second locating socket 46 may define interlocking shapes that provide lateral and longitudinal alignment for the first connector body 20 and second connector body 24 as the first circuit board 12 and second circuit board 14 are assembled to each other. The placement of the first locating pin 36 and first location socket and the second locating pin 44 and the second locating socket 46 may define a hermaphroditic connector body that will allow the same connector body to be used as the first connector body 20 or the second connector body 24. This may provide an advantage of doubling the production volume of the connector body and simplifying the circuit board assembly.

The first locating pin 36 may be tapered in both the lateral direction 40 and the longitudinal direction 42 to provide a generous amount of lead-in and/or alignment to facilitate assembly of the first connector body 20 to the second connector body 24. The taper may be wider at the top of the connector body and narrower at the bottom of the connector body. As used herein, the bottom of the connector body is the potion configured to be adjacent to the circuit board. The taper of the first locating pin 36 and the second locating pin 44 may provide easier assembly of the first locating pin 36 and the second locating pin 44 with the first locating socket 38 and the second locating socket 46.

The first locating pin 36 and first location socket and the second locating pin 44 and the second locating socket 46 do not necessarily provide alignment in the vertical direction 48 for the first connector body 20 and second connector body 24. The alignment in the vertical direction 48 may be determined by the assembly tolerance between the first circuit board 12 and the second circuit board 14.

The first locating pin 36 and the second locating pin 44 may define a head portion 50 and a body portion 52. The head portion 50 may be wider than the body portion 52 in order to define the interlocking shape. The first locating socket 38 and the second locating socket 46 may therefore define a complementary shape wherein the head portion 50 is also wider than the body portion 52. The head portion 50 may define a frustoconical shape and the body portion 52 may define a trapezoidal prism shape. The first locating socket 38 may define a shape characterized as generally having a keyhole shape. The corners of the keyhole shape may be radiused to provide greater mechanical strength for the connector body by reducing stress concentration at the corners. As used herein, a keyhole shape may be defined as a shape formed by the intersection of an elliptical shape and a trapezoidal shape, wherein two vertices of the trapezoid are contained within the ellipse and two edges of the trapezoid intersect the ellipse. The elliptical shape would also encompass a circular shape and the trapezoidal shape would also encompass a rectangular shape. Alternatively, the first locating pin 36 may define any shape that is interlocking, that is a shape that will inhibit relative movement between the first connector body 20 and the second connector body 24 in the longitudinal direction 42 and/or lateral direction 40.

Referring again to FIG. 2, the electrical connector assembly 10 also includes a conductor 54 disposed within the U-shaped portion 32 of the first terminal 30 and disposed within the U-shaped portion 32 of the second terminal 34. The conductor 54 is configured to electrically connect the first terminal 30 to the second terminal 34. The conductor 54 may define a blade, bar, rod, or staple shape. The conductor 54 may be a rigid structure. The conductor 54 may be formed from a strip of stock material cut to an appropriate length during the assembly process. The conductor 54 may be formed of copper to provide maximum conductivity. The conductor 54 may preferably be formed of half hard copper (ASTM B152, temper HO2) typically with a thickness of 0.8 millimeters to 1.2 millimeters to provide sufficient mechanical strength. The thickness of the conductor 54 may also be dependent on the current carrying capacity required. The conductor 54 is preferably tin plated. Silver or gold plating may also be used, but may not be preferred due to typically higher cost than tin plating.

The first terminal 30 and the second terminal 34 may be oriented so that the U-shaped portion 32 of the terminals are parallel to each other when assembled within the first connector body 20 and the second connector body 24, so that the conductor 54 may be inserted into the U-shaped portion 32 of the terminals to connect the first terminal 30 to the second terminal 34 in the longitudinal direction 42.

Without subscribing to any particular theory of operation, the electrical connector assembly 10 may provide the advantage of locating the first terminal 30 and the second terminal 34 relative to each other in the lateral direction 40 by the interaction of the first locating pin 36 and the first locating socket 38. The first terminal 30 and the second terminal 34 may be further located in the lateral direction 40 by the interaction of the second locating pin 44 and the second locating socket 46.

The U-shaped portion 32 of the first terminal 30 and the U-shaped portion 32 of the second terminal 34 may provide an advantage of sufficient assembly tolerance between the first terminal 30 and the second terminal 34 in the longitudinal direction 42 when the first connector body 20 is assembled to the second connector body 24 and the conductor 54 is inserted into the first terminal 30 and the second terminal 34. Connection points between the first terminal 30 and the conductor 54 and connection points between the second terminal 34 and the conductor 54 are not tightly constrained in the longitudinal direction 42 because the first terminal 30 or second terminal 34 may establish electrical contact at any point along the length of the conductor 54.

Similarly, the U-shaped portion 32 of the first terminal 30 and the U-shaped portion 32 of the second terminal 34 may also provide the advantage of providing sufficient assembly tolerance between the first terminal 30 and the second terminal 34 in the vertical direction 48 when the first connector body 20 is assembled to the second connector body 24 and the conductor 54 is inserted into the first terminal 30 and the second terminal 34. The connection points between the first terminal 30 and the conductor 54 and the connection points between the second terminal 34 and the conductor 54 are not tightly constrained in the vertical direction 48 because the first terminal 30 or second terminal 34 may establish electrical contact at any point along the height of the conductor 54.

The first terminal 30 and the second terminal 34 may be formed by stamping a sheet of the terminal material in a progressive die while leaving material that may be used as a carrier and rolling the terminals onto a reel. The first terminal 30 and the second terminal 34 may be singulated from the reel by a stamp/assembly tool when the first terminal 30 and the second terminal 34 are assembled to the first connector body 20 and second connector body 24. The first terminal 30 and the second terminal 34 may be press-fit (or insert molded) into an injection molded connector body and permits significant assembly tolerance in the longitudinal direction 42 for the electrical connector assembly 10. The sheared carrier on the first terminal 30 and the second terminal 34 may function as a press-fit interference in the first connector body 20 or the second connector body 24 and retain the first terminal 30 or the second terminal 34 in the first connector body 20 or the second connector body 24. These designs may permit simple stamping and minimizes damage caused by placing the terminals on a reel. The manufacturing techniques used to form terminals are well known to those skilled in the art.

The first terminal 30 and the second terminal 34 may define a tuning fork shape. A tuning fork shaped terminal may be preferred to provide a significant assembly tolerance between the first connector body 20 and the second connector body 24 in the longitudinal direction 42 and vertical direction 48.

Referring once more to FIG. 2, the electrical connector assembly 10 may include a plurality of first terminals, a plurality of second terminals and a plurality of conductors. The first connector body 20 and the second connector body 24 may define isolation walls between neighboring first and second terminals and neighboring conductors to provide electrical isolation between neighboring terminals and conductors.

The electrical connector assembly 10 may include a cover 60 that is configured to mechanically couple the first connector body 20 to the second connector body 24. The cover 60 may also be configured to align the first connector body 20 and the second connector body 24 in the longitudinal direction 42, lateral direction 40, and/or vertical direction 48. The cover 60 may include a locking feature 62 to lock the cover 60 to the first connector body 20 and/or the second connector body 24. The locking feature 62 may define a loop or “pump handle” that is configured to interface with a ramp feature 64 defined by the first connector body 20 or the second connector body 24.

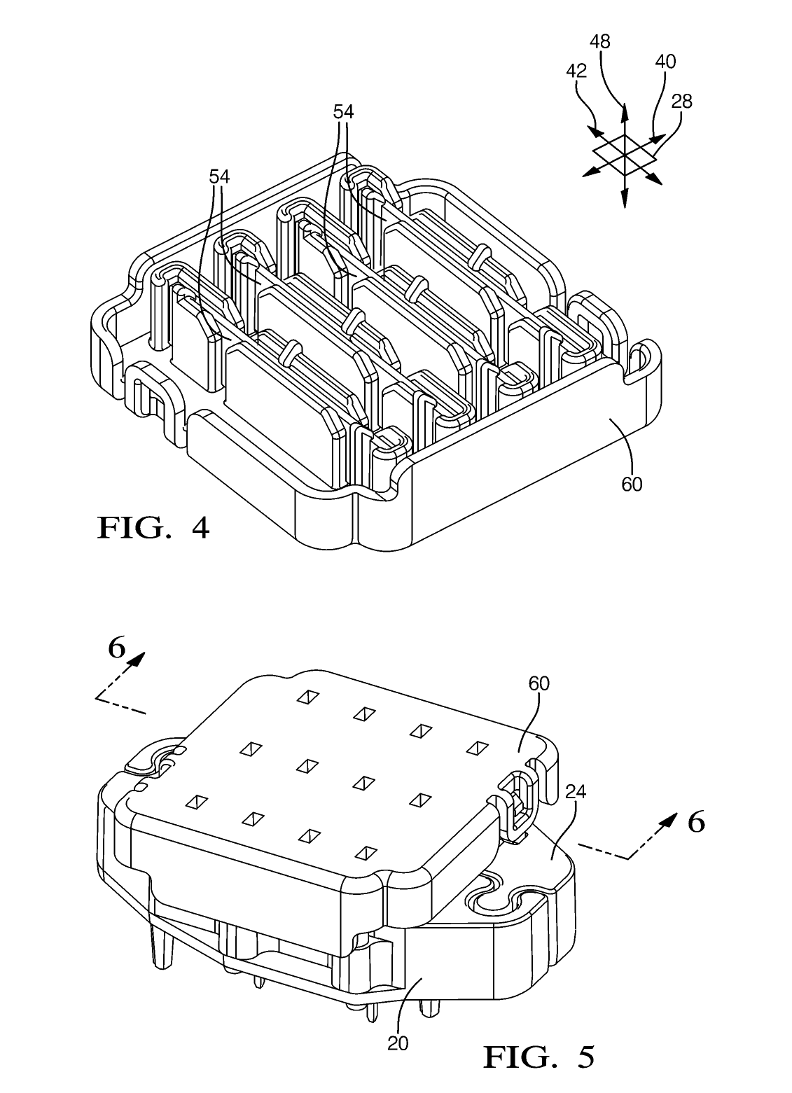

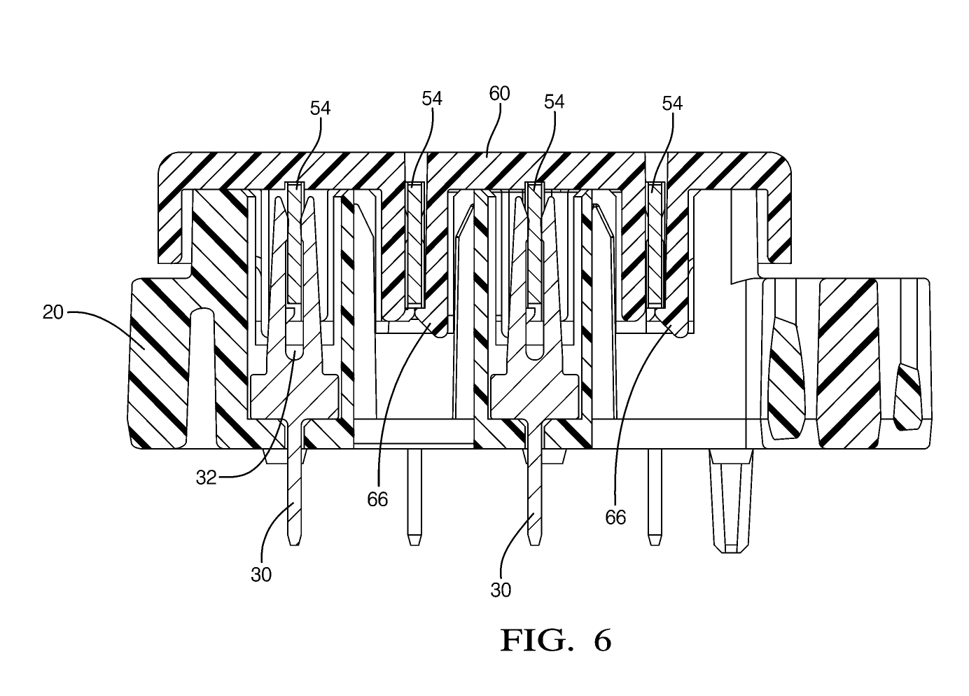

As illustrated in FIG. 4, the conductor 54 may be disposed within the cover 60. The cover 60 may be configured to align the conductor 54 to the first terminal 30 and the second terminal 34 in the lateral direction 40. The cover 60 may also be configured to align the conductor 54 to the first terminal 30 and the second terminal 34 in the longitudinal direction 42 and/or the vertical direction 48. As illustrated in FIGS. 5 and 6, the cover 60 may define a retaining feature 66 configured to secure the conductor 54 within the cover 60.

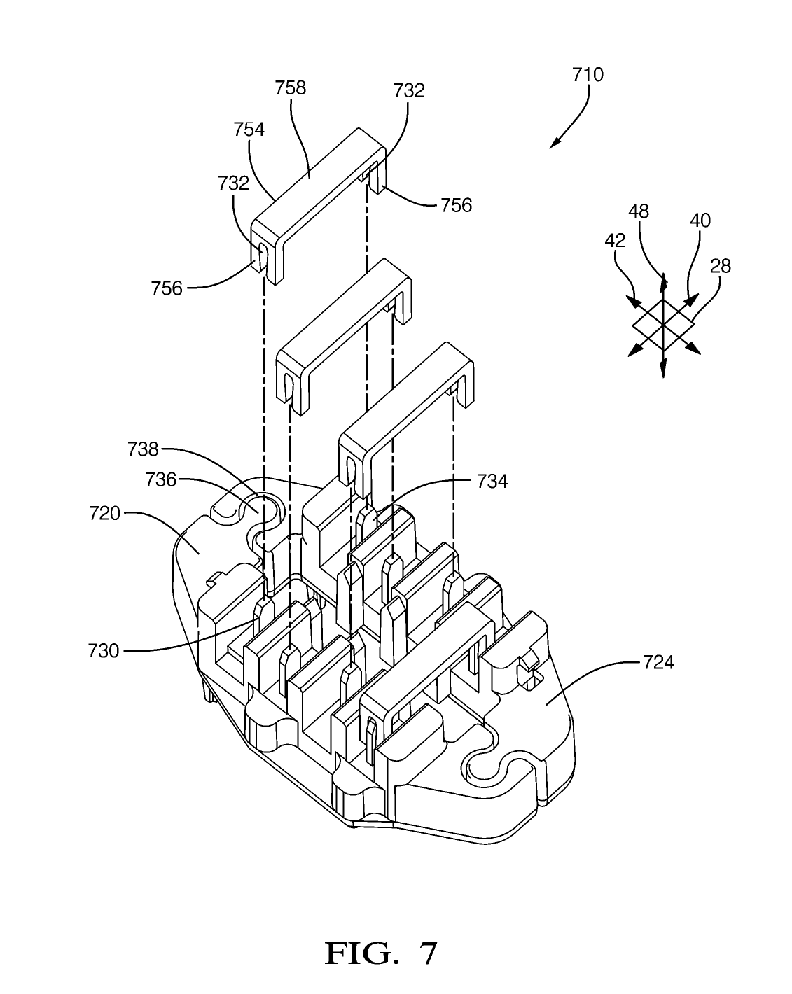

FIG. 7 illustrates a non-limiting alternative example of the electrical connector assembly 710, wherein the conductor 754 defines a staple shape having two leg portions 756 and a central portion 758 and wherein the first terminal 730 and the second terminal 734 define a blade shape. The leg portions of the conductor 754 further define a U-shaped portion 732 that is configured to engage a first terminal 730 and a second terminal 734. Similar to the U-shaped portion 32 of the first terminal 30 and the U-shaped portion 32 of the second terminal 34, the U-shaped portions 732 defined by the conductor 754 may provide assembly tolerance in the longitudinal direction 42 and the vertical direction 48. The first terminal 730 is formed of electrically conductive material and is configured to electrically connect to a first circuit board 12. The second terminal 734 is formed of electrically conductive material and is configured to electrically connect to a second circuit board 14. The electrical connector assembly 710 includes a first connector body 720 configured to position the first terminal 730 relative to a first locating pin 736 defined by the first connector body 720. The first locating pin 736 is configured to protrude from the first connector body 720. The electrical connector assembly 710 also includes a second connector body 724 configured to position the second terminal 734 relative to a first locating socket 738 defined by the second connector body 724. The first locating socket 738 has a shape complementary to the first locating pin 736. The first locating pin 736 and the first locating socket 738 cooperate to align the first terminal 730 and the second terminal 734 in the lateral direction 40.

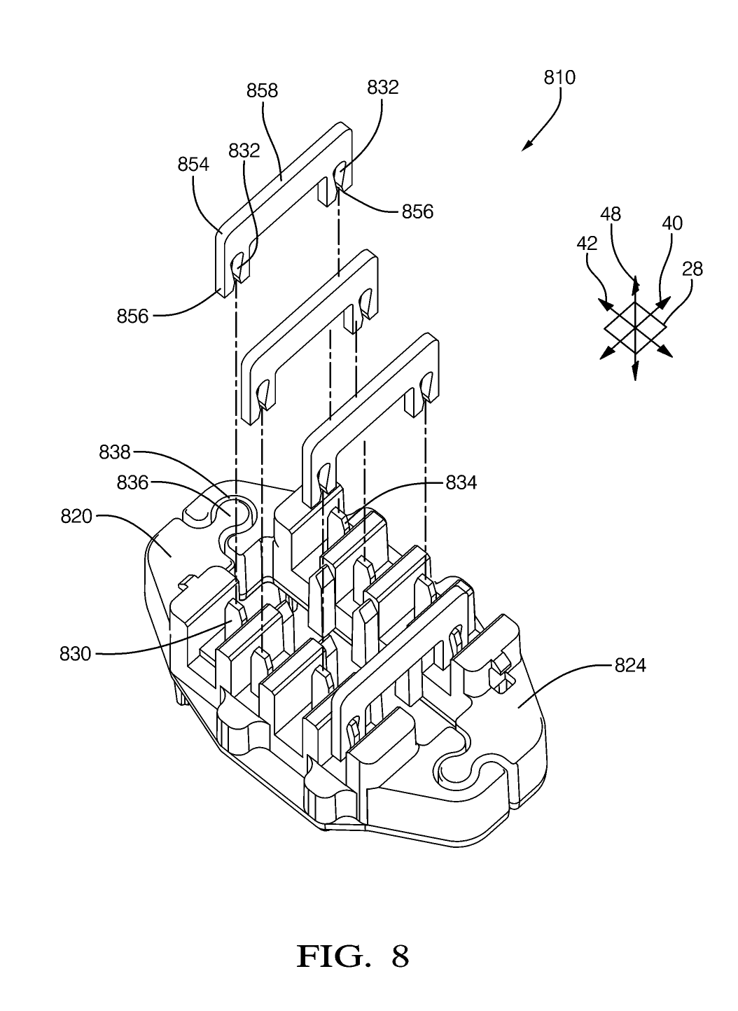

FIG. 8 illustrates a yet another non-limiting alternative example of the electrical connector assembly 810, wherein the conductor 854 defines a staple shape having two leg portions 856 and a central portion 858 and wherein the first terminal 830 and the second terminal 834 define a blade shape. The leg portions of the conductor 854 further define a U-shaped portion 832 that is configured to engage a first terminal 830 and a second terminal 834. Similar to the U-shaped portion 32 of the first terminal 30 and the U-shaped portion 32 of the second terminal 34, the U-shaped portions 832 defined by the conductor 754 may provide assembly tolerance in the vertical direction 48. Due to the orientation of the U-shaped portion 832, the conductor 854 may provide assembly tolerance in the lateral direction 40 rather than the longitudinal direction 42. The first terminal 830 is formed of electrically conductive material and is configured to electrically connect to a first circuit board 12. The second terminal 834 is formed of electrically conductive material and is configured to electrically connect to a second circuit board 14. The electrical connector assembly 810 includes a first connector body 820 configured to position the first terminal 830 relative to a first locating pin 836 defined by the first connector body 820. The first locating pin 736 is configured to protrude from the first connector body 820. The electrical connector assembly 810 also includes a second connector body 824 configured to position the second terminal 834 relative to a first locating socket 838 defined by the second connector body 824. The first locating socket 838 has a shape complementary to the first locating pin 836. The first locating pin 836 and the first locating socket 838 cooperate to align the first terminal 830 and the second terminal 834 in the lateral direction 40.

FIG. 1 also illustrates a non-limiting example of a battery pack system 100 configured for use in an electrical vehicle. The battery pack system 100 includes a first battery 102 further comprising a first circuit board 12 and a second battery 104 further comprising a second circuit board 14. The first circuit board 12 and second circuit board 14 may be a printed circuit board (PCB) containing conductive traces configured to connect electrical components 18 and to connect the first battery 102 to the second battery 104.

The first circuit board 12 and the second circuit board 14 may include battery monitoring and control circuitry, configured to monitor and/or control battery voltage, battery current, battery temperature, battery state of charge, or any other battery parameters of interest. The battery pack system 100 may also include a battery pack controller. Battery monitoring and control data may be communicated between the battery pack controller and the battery monitoring and control circuitry via low voltage signal circuitry, eliminating the need for high voltage signal transmission from each battery to the battery pack controller. This provides the advantages of eliminating packaging space and weight of high voltage cables from each battery to the battery pack controller. It also provides the advantages on improved reliability since the probability of a high voltage short circuit is reduced.

The first battery 102 is electrically connected to the second battery 104 via the electrical connector assembly 10 and the conductive traces 16 of the first circuit board 12 and the second circuit board 14. The first battery 102 and the second battery 104 may be connected in series so that the battery pack system 100 may provide higher voltage than a single battery or the first battery 102 and the second battery 104 may be connected in parallel so that the battery pack system 100 may provide higher current than a single battery. The electrical connector assembly 10 may also be configured to connect battery monitoring circuits between the first circuit board 12 and the second circuit board 14.

The battery pack system 100 further includes a first connector body 20 configured to position the first terminal 30 relative to a first locating pin 36 defined by the first connector body 20. The first locating pin 36 is configured to protrude from the first connector body 20. The battery pack system 100 also includes a second connector body 24 configured to position the second terminal 34 relative to a first locating socket 38 defined by the second connector body 24. The first locating socket 38 has a shape complementary to the first locating pin 36. The first locating pin 36 and the first locating socket 38 cooperate to align the first terminal 30 and the second terminal 34 in a lateral direction 40.

Accordingly, an electrical connector assembly 10 and a battery pack system 100 configured for use in an electrical vehicle is provided. The electrical connector assembly 10 provides the advantage of providing lateral location of the terminals on adjoining circuit boards while providing sufficient assembly tolerances in the longitudinal direction 42 and the vertical direction 48. The electrical connector assembly 10 may also provide the advantage of using a single connector body and terminal design to connect two circuit boards.

The electrical connector assembly 10 used with battery pack system 100 may provide an additional benefit of simplifying assembly of the battery pack system 100 by installing the first battery 102 in the battery pack system 100, then engaging the first locating pin 36 of the first connector body 20 on the first battery 102 with the first locating socket 38 of the second connector body 24 on the second battery 104 while installing the second battery 104 into the battery pack system 100, thus laterally aligning the first terminal 30 with the second terminal 34. The first terminal 30 and the second terminal 34 may be electrically connected by engaging the conductor 54 with the first terminal 30 and the second terminal 34, preferably by engaging the cover 60 containing the conductor 54 on the first connector body 20 and the second connector body 24.

The electrical connector assembly 10 also provides an advantage for servicing a battery within the battery pack system 100. The first battery 102 may be electrically and physically disconnected from the second battery 104 by removing the cover 60. The first battery 102 may then be removed from the battery pack system 100 and a replacement first battery 102 may be inserted in the battery pack system 100 by aligning the first location pin of the first connector body 20 with the first locating socket 38 of the second connector body 24 and replacing the cover 60 on the first connector body 20 and the second connector body 24.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. An electrical connector assembly configured to interconnect a plurality of circuit boards, said assembly comprising:
a first terminal formed of electrically conductive material, said first terminal configured to define a U-shaped portion and electrically connect to a first circuit board;
a second terminal formed of electrically conductive material, said second terminal configured to define a U-shaped portion and electrically connect to a second circuit board;
a conductor disposed within the U-shaped portion of the first terminal and disposed within the U-shaped portion of the second terminal;
a first connector body configured to position the first terminal relative to a first locating pin defined by the first connector body, said first locating pin configured to protrude from the first connector body; and
a second connector body configured to position the second terminal relative to a first locating socket defined by the second connector body, said first locating socket having a shape complementary to the first locating pin, wherein the first locating pin and the first locating socket cooperate to align the first terminal and the second terminal in a lateral direction.

2. The assembly of claim 1, wherein the first connector body is configured to be disposed proximate to a first circuit board edge and the second connector body is configured to be disposed proximate to a second circuit board edge.

3. The assembly of claim 2, wherein the first circuit board is coplanar with the second circuit board.

4. The assembly of claim 1, wherein the second connector body further defines a second locating pin, said second locating pin configured to protrude from the second connector body, wherein the first connector body further defines a second locating socket within the first connector body having a shape complementary to the second locating pin, and wherein the second locating pin and the second locating socket cooperate to further align the first connector body and the second connector body in the lateral direction.

5. The assembly of claim 4, wherein the first locating pin and the second locating pin define the same shape.

6. The assembly of claim 1, wherein the first locating pin is tapered.

7. The assembly of claim 1, wherein the first locating pin and the first locating socket define interlocking shapes.

8. The assembly of claim 7, wherein the first locating pin and the first locating socket are configured to mechanically couple the first circuit board to the second circuit board and cooperate to align the first terminal and the second terminal in a longitudinal direction.

9. The assembly of claim 7, wherein the first locating pin defines a head portion and a body portion, wherein the head portion is wider than the body portion to define the interlocking shape.

10. The assembly of claim 9, wherein the head portion defines a frustoconical shape and the body portion defines a trapezoidal prism shape.

11. The assembly of claim 10, wherein the first locating socket defines a keyhole shape.

12. The assembly of claim 1, wherein the conductor is disposed within a cover configured to mechanically couple the first circuit board to the second circuit board and to align the first terminal and the second terminal in a longitudinal direction.

13. The assembly of claim 1, wherein the conductor defines a blade shape.

14. The assembly of claim 1, wherein the first terminal and the second terminal define a tuning fork shape.

15. An electrical connector assembly configured to interconnect a plurality of circuit boards, said assembly comprising:
a first terminal formed of electrically conductive material, said first terminal configured to electrically connect to a first circuit board;
a second terminal formed of electrically conductive material, said second terminal configured to electrically connect to a second circuit board;
a conductor defining a first leg portion and a second leg portion wherein the first terminal is disposed within a U-shaped portion defined by the first leg portion and the second terminal is disposed within a U-shaped portion defined by the second leg portion;
a first connector body configured to position the first terminal relative to a first locating pin defined by the first connector body, said first locating pin configured to protrude from the first connector body; and
a second connector body configured to position the second terminal relative to a first locating socket defined by the second connector body, said first locating socket having a shape complementary to the first locating pin, wherein the first locating pin and the first locating socket cooperate to align the first terminal and the second terminal in a lateral direction.

16. The assembly of claim 15, wherein the first connector body is configured to be disposed proximate to a first circuit board edge and the second connector body is configured to be disposed proximate to a second circuit board edge.

17. The assembly of claim 16, wherein the first circuit board is coplanar with the second circuit board.

18. The assembly of claim 15, wherein the second connector body further defines a second locating pin, said second locating pin configured to protrude from the second connector body, wherein the first connector body further defines a second locating socket within the first connector body having a shape complementary to the second locating pin, and wherein the second locating pin and the second locating socket cooperate to further align the first connector body and the second connector body in the lateral direction.

19. The assembly of claim 18, wherein the first locating pin and the second locating pin define the same shape.

20. The assembly of claim 15, wherein the first locating pin is tapered.

21. The assembly of claim 15, wherein the first locating pin and the first locating socket define interlocking shapes.

22. The assembly of claim 21, wherein the first locating pin and the first locating socket are configured to mechanically couple the first circuit board to the second circuit board and cooperate to align the first terminal and the second terminal in a longitudinal direction.

23. The assembly of claim 21, wherein the first locating pin defines a head portion and a body portion, wherein the head portion is wider than the body portion to define the interlocking shape.

24. The assembly of claim 23, wherein the head portion defines a frustoconical shape and the body portion defines a trapezoidal prism shape.

25. The assembly of claim 24, wherein the first locating socket defines a keyhole shape.

26. The assembly of claim 15, wherein the conductor is disposed within a cover configured to mechanically couple the first circuit board to the second circuit board and to align the first terminal and the second terminal in a longitudinal direction.

27. A battery pack system configured for use in an electrical vehicle, said system comprising:
a first battery further comprising a first circuit board and a second battery further comprising a second circuit board, wherein the second battery is electrically connected to the first battery via the first circuit board and the second circuit board; and
an electrical connector assembly configured to interconnect a the first circuit board and the second circuit board, wherein said electrical connector assembly further comprises,
a first connector body configured to position the first terminal relative to a first locating pin defined by the first connector body, said first locating pin configured to protrude from the first connector body, and
a second connector body configured to position the second terminal relative to a first locating socket defined by the second connector body, said first locating socket having a shape complementary to the first locating pin, wherein the first locating pin and the first locating socket cooperate to align the first terminal and the second terminal in a lateral direction.

28. The system of claim 27, wherein said electrical connector assembly further comprises,
a first terminal formed of electrically conductive material, said first terminal configured to define a U-shaped portion and electrically connected to the first circuit board;
a second terminal formed of electrically conductive material, said second terminal configured to define a U-shaped portion and electrically connected to the second circuit board, and
a conductor disposed within the U-shaped portion of the first terminal and disposed within the U-shaped portion of the second terminal.

29. The system of claim 27, wherein said electrical connector assembly further comprises,
a first electrically conductive terminal electrically connected to the first circuit board,
a second electrically conductive terminal electrically connected to the second circuit board, and
a conductor defining a first leg portion and a second leg portion, wherein the first terminal is disposed within a U-shaped portion defined by the first leg portion and the second terminal is disposed within a U-shaped portion defined by the second leg portion.

30. The system of claim 27, wherein the second connector body further defines a second locating pin, said second locating pin configured to protrude from the second connector body, wherein the first connector body further defines a second locating socket within the first connector body having a shape complementary to the second locating pin, and wherein the second locating pin and the second locating socket cooperate to further align the first connector body and the second connector body in the lateral direction.
